(19) United States
(12) Patent Application Publication
(10) Pub. No.: US 2011/0056778 A1
(43) Pub. Date: Mar. 10, 2011

(54) Brake Lining Arrangement for Disc Brakes

(76) Inventors: Klaus Roth, Neuhausel (DE); Dirk Hees, Mayen (DE)

(21) Appl. No.: 12/990,992

(22) PCT Filed: May 4, 2009
(86) PCT No.: PCT/EP09/03200

§ 371 Date: Nov. 17, 2010

(30) Foreign Application Priority Data
May 6, 2008 (DE) 10 2008 022 200.3

(51) Int. Cl. F16D 65/092

(52) U.S. Cl. 188/234

(57) ABSTRACT

The invention relates to a brake lining arrangement for disc brakes having at least one spring journal arranged on the back of the brake lining and a spring element that may be coupled to the spring journal, wherein the spring element has a fastening section with a receiving opening for receiving the spring journal, wherein on the surface of the fastening section of the spring element remote from the brake lining a profiling is configured, which during a plastic deformation of the spring journal to fix the spring element comes into engagement therewith and fixes the spring element in a predetermined position.

### CROSS-REFERENCE TO RELATED APPLICATIONS

This application is a national stage of International Application No. PCT/EP2009/003200 filed May 4, 2009, the disclosures of which are incorporated herein by reference in entirety, and which claimed priority to German Patent Application No. 10 2008 022 200.3 filed May 6, 2008, the disclosures of which are incorporated herein by reference in entirety.

### BACKGROUND OF THE INVENTION

The invention relates to a brake lining arrangement for disc brakes having at least one spring journal arranged on the back of the brake lining and a spring element that may be coupled to the spring journal, wherein the spring element has a fastening section with a receiving opening for receiving the spring journal.

Such an arrangement is known for example from EP 0 609 245 B1. In this brake lining arrangement, for fastening a retaining spring, by means of which the brake lining plus plate-shaped brake lining carrier is held in a caliper arrangement, there is formed on a lining backplate a projection, which projects from the plate plane. For fastening the retaining spring to the lining backplate the retaining spring has an opening, by which it may be placed over the projection and moved into a correct angular position. Once the retaining spring is in a correct position, the projection is riveted, i.e. plastically deformed, so that it broadens sideways, projects beyond the edges of the opening and presses the retaining spring onto the lining backplate. During the riveting operation the portion of the projection protruding through the opening also deforms. The cross section of the projection is likewise broadened by the riveting operation until it abuts the edges of the opening and adapts its shape to the square shape of the opening.

This retaining spring, despite the riveted joint, may twist out of its setpoint position or even detach itself from the projection on the lining backplate because it is held in position only by the adaptation of the projection to the shape of the opening. Especially during operation of a disc brake with a brake pad according to EP 0 609 245 B1 the vibrations and impacts arising in a vehicle may easily cause the opening of the retaining spring or the projection to become deformed and no longer capable of preventing a twisting of the retaining spring. Furthermore, after the riveting operation it is impossible by visual inspection to establish reliably enough whether the cross section of the projection has enlarged sufficiently and an adequate positive connection between both components has been produced.

### BRIEF SUMMARY OF THE INVENTION

A feature of the present invention is therefore to provide a brake lining arrangement, with which a spring element is retained in a permanently twistproof manner at its predetermined position and its fastening may be checked.

This feature is achieved by a brake lining arrangement of the initially described type, in which on the surface of the fastening section of the spring element remote from the brake lining a profiling is configured, which during a plastic deformation of the spring journal to fix the spring element comes into engagement therewith and fixes the spring element in a predetermined position. During assembly the spring journal, as in the prior art, is plastically deformed. Its material then flows into the profiling and, on the one hand, provides twist proofing and, on the other hand, makes it possible to identify whether an adequate fastening of the spring element as a result of the plastic deformation of the spring journal is guaranteed.

A development of the invention provides that the surface of the fastening section has an irregular surface structure, in particular in the form of toothing, knurling or fluting. In this connection it should be mentioned that the irregular surface structure may according to the invention be configured at least in sections around the receiving opening.

In order to achieve maximum security against twisting and/or a permanent fastening of the spring element in a predetermined position, a preferred form of construction of the invention provides that the spring journal is plastically deformed by riveting or caulking, wherein a positive connection is produced between the spring element and the profiled surface of the spring element. By virtue of the plastic deformation the spring journal is deformed in such a way that it engages into the surface structure of the spring element and produces the said positive connection between these two components. Furthermore, as is likewise indicated above, after the riveting operation it is possible to establish by visual inspection whether an adequate positive connection has been produced between the profiled surface and the spring journal.

With regard to the arrangement of the spring journal on the brake lining arrangement, it may be provided that the spring journal is formed directly on the brake lining and/or a plate-shaped brake lining carrier or takes the form of a separate component, for example in the form of a separate bolt, that is mountable on the brake lining. In this connection it should further be mentioned that the spring journal may comprise a rivet head.

For mounting the brake lining arrangement on the brake piston of a disc brake, a form of construction of the invention provides that the spring element has on its end a bow section with a detent formation. Furthermore, for mounting the spring element on the brake lining arrangement, according to a preferred form of construction of the invention there are formed on the brake lining projections, to which the spring element may be fastened by means of the spring journal, wherein in this case the bow section of the spring element projects above the projections.

For positioning and/or centering the brake lining arrangement during mounting onto a brake and/or a brake piston, it may further be provided that the brake lining has positioning elements.

The invention further relates to a disc brake having a brake lining arrangement according to the invention.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective partial view of a brake lining arrangement according to the invention;

FIG. 2 is a side view of the brake lining arrangement according to FIG. 1;

FIG. 3 is a front view of the brake lining arrangement according to FIG. 1;

FIG. 4 is a perspective overall view of the brake lining arrangement according to the invention.

### DETAILED DESCRIPTION OF THE INVENTION

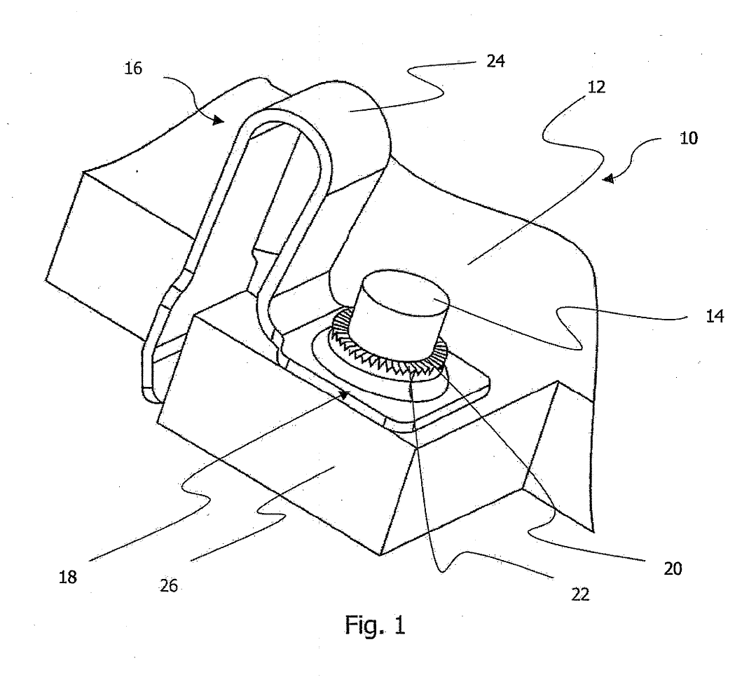

FIG. 1 shows a brake lining arrangement 10 having a spring journal 14, which is arranged on the back of the brake lining 12, and a spring element 16 after the rivet fastening of the spring journal 14. Further evident from FIG. 1 is a fastening section 18 of the spring element 16 that has an irregular surface structure 22 and/or profiling at least in sections around a receiving opening 20. The surface structure may be configured in particular in the form of toothing, knurling or fluting. On the spring element 16 a bow section 24 is further provided, by means of which a fastening of the brake lining arrangement 10 to a brake piston (not shown) of a disc brake is possible.

FIG. 1 further shows a projection 26, to which the spring element 16 may be fastened by means of the spring journal 14. It is further evident that the end region of the bow section 24 projects above the projection 26 into the cross section of the brake lining 12.

In order to fasten the spring element 16 to the brake lining 12, the spring element 16 is fitted onto the spring journal 14. For this purpose the spring element 16 receives the spring journal 14 in its receiving opening 20. The spring element 16 is brought with its fastening section 18 into a predetermined position on the projection 26. Then the spring journal 14 is plastically deformed, i.e. riveted or caulked. By virtue of the plastic deformation material of the spring journal 14 flows in the region of the profiled surface 22 on the fastening section 18 of the spring element 16 and comes into positive engagement therewith. The material of the spring journal 14 therefore flows as a result of its plastic deformation into the tooth spaces of the profiled surface structure 22 of the fastening section 18. A positive connection to the surface structure 22 of the fastening section 18 is therefore produced, by means of which the spring element 16 is fastened in a fixed and twistproof manner to the back of the brake lining 12.

Following the previously described assembly it is possible by visual inspection to check whether an adequate positive connection has been produced between the profiled surface 22 and the spring journal 14.

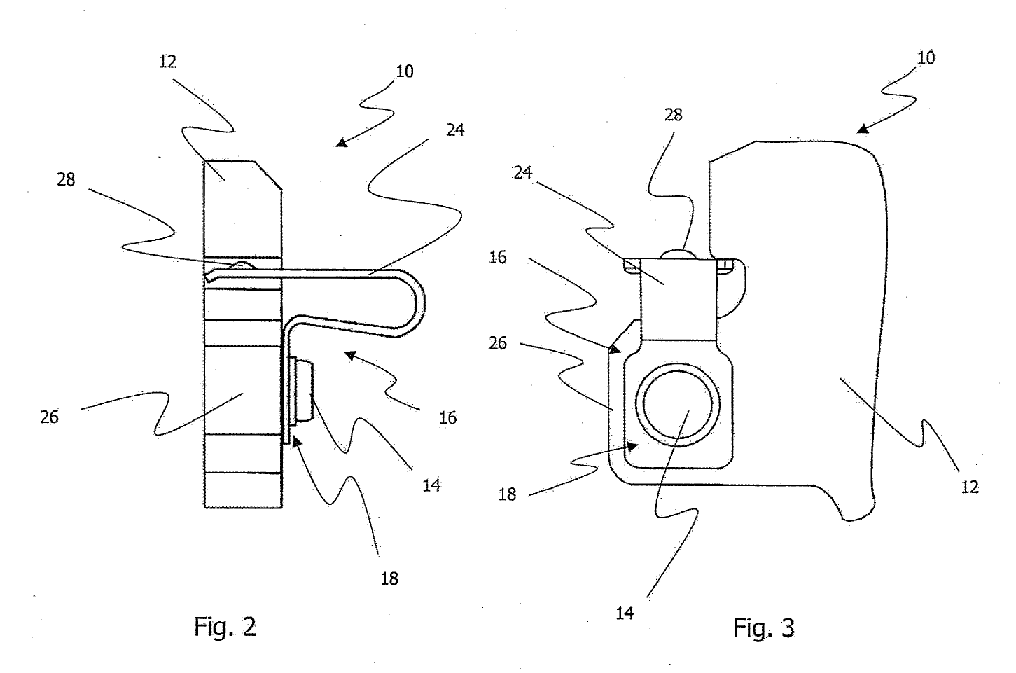

FIG. 2 shows a side view of the brake lining arrangement 10 after riveting or caulking of the spring journal 14. It may be seen clearly from FIG. 2 that the cross section of the spring journal 14 has enlarged and that by means of the irregular surface structure 22 (not shown here) a positive connection has been produced between the spring journal 14 and the surface structure of the fastening section 18 of the spring element 16. It is equally evident from FIG. 2 that the bow section 24 of the spring element 16 above the projection 26 overlaps the brake lining 12. The bow section 24 on its end that projects above the projection 26 has a detent formation 28, by means of which the brake lining 12 may establish a detent connection with a corresponding counterpart on a brake piston (not shown) and/or a caliper arrangement of a disc brake.

FIG. 3 shows a front view of the brake lining arrangement after the riveting operation. One may therefore see once more the projection 26, on which the spring element 16 is arranged by its fastening section 18, and the bow section 24 projecting above the projection 26. Further evident from FIG. 3 is the detent formation 28 on the bow section 24 of the spring element 16.

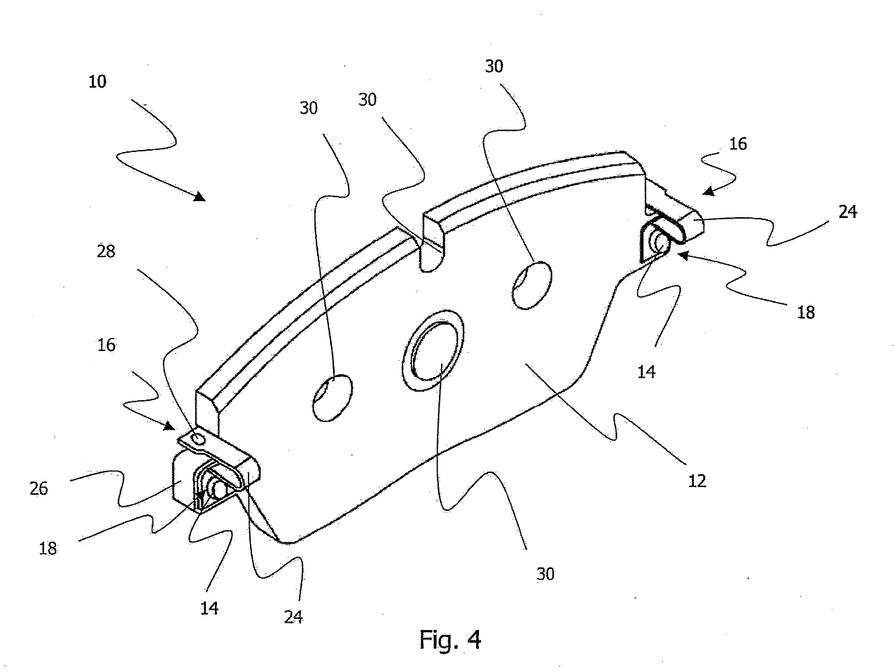

FIG. 4 shows a perspective overall view of the brake lining arrangement 10 that moreover clearly shows the position of the spring elements 16 on the brake lining 12. Formed on the sides of the brake lining 12 are the previously mentioned projections 26, to which the two spring elements 16 may be fastened by their fastening sections 18 by means of the spring journals 14. Above the projections 26 the bow section 24 of the spring elements 16 overlaps the brake lining 12.

Further evident from FIG. 4 are positioning elements 30 for positioning and/or centering the brake lining arrangement 10 on a brake piston (not shown) of a caliper brake arrangement. The positioning elements 30 facilitate and speed up assembly of the brake lining arrangement because counterparts corresponding to the positioning elements 30 are formed on the brake pistons.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake lining arrangement for disc brakes having at least one spring journal arranged on the back of the brake lining and a spring element that may be coupled to the spring journal, wherein the spring element has a fastening section with a receiving opening for receiving the spring journal, wherein on the surface of the fastening section of the spring element remote from the brake lining a profiling is configured, which during a plastic deformation of the spring journal to fix the spring element comes into engagement therewith and fixes the spring element in a predetermined position.

2. Brake lining arrangement according to claim 1, wherein the surface of the fastening section has an irregular surface structure.

3. Brake lining arrangement according to claim 2, wherein the irregular surface structure is formed at least in sections around the receiving opening.

4. Brake lining arrangement according to claim 1,
wherein the spring journal is plastically deformable, by riveting or caulking, wherein a positive connection is produced between the spring element and the surface of the spring element.

5. Brake lining arrangement according to claim 1,
wherein the spring element is formed directly on the brake lining or takes the form of a separate component that is mountable on the brake lining.

6. Brake lining arrangement according to claim 4, wherein the spring journal comprises a rivet head.

7. Brake lining arrangement according to claim 1,
wherein the spring element has on it's an end a bow section with a detent formation.

8. Brake lining arrangement according to claim 7,
wherein there are formed on the brake lining projections, to which the spring element may be fastened by means of the spring journal, wherein the bow section of the spring element projects above the projections.

9. Brake lining arrangement according to claim 1,
wherein the brake lining has positioning elements.

10. Disc brake having a brake lining arrangement according to claim 1.

11. Brake lining arrangement according to claim 2, wherein the irregular surface structure is in the form of one of toothing, knurling or fluting.
